(19) United States
(12) Patent Application Publication
(10) Pub. No.: US 2026/0175996 A1
(43) Pub. Date: Jun. 25, 2026

(54) EXTERNAL POWER SUPPLY MODULE FOR AN AIRCRAFT

(71) Applicant: AIRBUS OPERATIONS SAS, Toulouse (FR)

(72) Inventors: Pierre DASTE, Toulouse (FR); Franck ALBERO, Toulouse (FR); Mohamed Khaled KAHALERRAS, Toulouse (FR)

(73) Assignee: AIRBUS OPERATIONS SAS, Toulouse (FR)

(21) Appl. No.: 19/421,885

(22) Filed: Dec. 16, 2025

(30) Foreign Application Priority Data
Dec. 20, 2024 (FR) 2414881

(51) Int. Cl. B64F 1/35; B60R 16/03; H02J 3/36

(52) U.S. Cl. CPC B64F 1/352; H02J 3/36; B60R 16/03

(57) ABSTRACT

A power supply module aircraft, including at least an electrical connection to a first AC distribution network, an electrical connection to a second AC distribution network, a synchronization and junction module, and a power converter, the power supply module being external to an aircraft. The power converter is configured to deliver to said aircraft a DC supply voltage obtained by the synchronization and junction module from the first and second AC distribution networks. Advantageously, it is thus possible to supply electrical energy to an aeroplane parked in an area of an airport, without requiring complex logistics and without having to use its auxiliary power unit.

### TECHNICAL FIELD

The present invention relates to an improved external power supply module for an aircraft, intended to supply electrical energy to an aircraft located in a parking area of an airport facility.

### PRIOR ART

Aircraft architectures are evolving, in particular with a view to substantially reducing carbon dioxide emissions. Recent or future architectures are thus more electrified and the density of electrical energy needed on board aircraft is greater, both on the ground and in flight. When an aeroplane is parked in an airport, the power supply it needs is generally provided to it by its auxiliary power unit (APU) or by a power source available on the ground in the form of a 115 V AC power supply network the power of which is limited, for example from a stationary or mobile generator set. Electrical power requirements are now increased for aircraft parked on the ground, and introducing on-board power converters in aircraft, adjusted accordingly, would be detrimental to the weight of the aircraft. In addition, providing new sources of electrical energy in airport facilities, sized accordingly, would lead to the need for more complex logistics with a significant financial impact.

The situation could be improved.

### SUMMARY OF THE INVENTION

An object of the present invention is to reconcile as well as possible the environmental needs for carbon dioxide reduction and the electrical energy needs for aircraft parked on the ground, while at the same time avoiding adding additional weight to the aircraft, and avoiding complex and expensive logistics on the ground.

To this end, the invention proposes a power supply module for supplying power to an aircraft, comprising at least a first input configured to make an electrical connection to a first AC distribution network and a power converter, the power supply module being external to an aircraft, and the supply module being such that the power converter is configured to deliver to the aircraft a DC supply voltage, from at least the first AC distribution network connected to the first input, via a first output configured for connection to the aircraft.

The power supply module for an aircraft comprises at least the first input connected to the first AC distribution network, a second input configured to make a connection to a second AC distribution network, as well as an internal module for synchronizing and joining two AC power supply lines which are connected to said first and second inputs, respectively, a synchronization output of which is connected to an input of the power converter configured to deliver, via said first output, said DC supply voltage from said two synchronized and joined power supply lines.

In one embodiment, the power supply module for an aircraft is configured to be connected to a plurality of stationary or mobile 115 V AC electrical sources. These electrical sources are those commonly found in airport infrastructures (non-exhaustive list): 115 V AC sockets accessible on the ground, generator sets, mobile battery packs, etc.

Advantageously, the power supply module is arranged in a mobile one-piece unit.

According to one embodiment, the supply module is arranged on or in a land-based motor vehicle.

According to one embodiment, the power supply module for an aircraft is such that its one or more inputs are each configured for connection to a network having an AC voltage of 115 V and operating at a frequency of 400 Hz, and its output is configured to deliver a DC voltage of between 270 V and 1000 V, preferentially of equal to 540 V or 800 V.

According to one embodiment, the output of the supply module is configured to deliver a DC voltage which is adjustable via a control user interface of the power supply module for an aircraft.

### BRIEF DESCRIPTION OF THE DRAWINGS

FIG. 1 schematically illustrates a power supply module for an aircraft according to one embodiment;

FIG. 2 schematically illustrates details for implementing the power supply module already shown in FIG. 1 according to a first variant embodiment;

FIG. 3 schematically illustrates details for implementing the power supply module already shown in FIG. 1 according to a second variant embodiment; and

FIG. 4 illustrates an exemplary architecture of an internal controller of a supply module according to one embodiment.

### DETAILED DESCRIPTION OF EMBODIMENTS

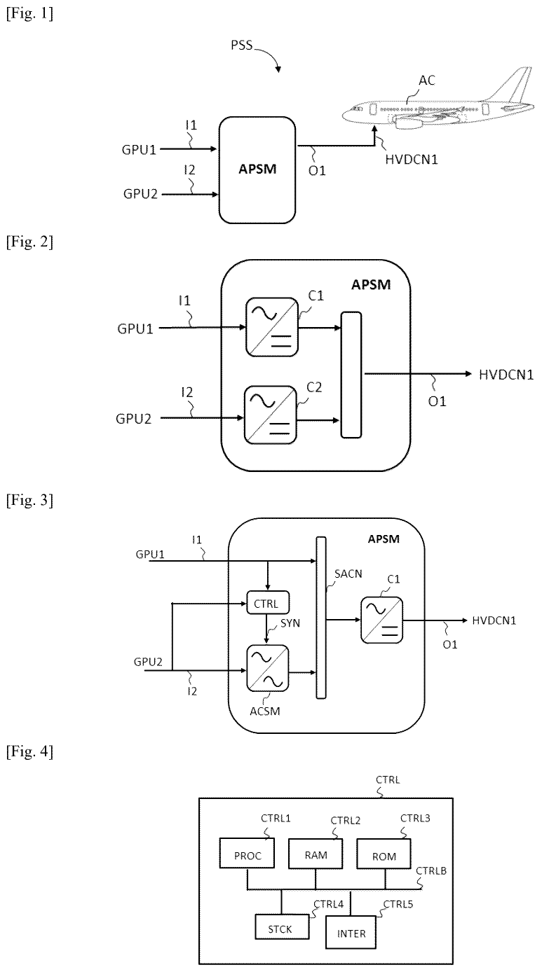

FIG. 1 schematically shows a system PSS for supplying power to an aircraft AC according to one embodiment. The system PSS is a system for supplying power to an aircraft AC in the sense that it is intended to supply electrical energy to the aircraft AC. According to the example described, the system PSS comprises a power supply module APSM as well as elements for connection to sources of electrical energy, which constitute inputs I1 and I2, also referred to here as input interfaces I1 and I2. The inputs I1 and I2 are each configured for connection to an AC power supply network. According to the non-limiting example described, the input I1 is configured to be connected to a first AC power supply network GPU1 and the input I2 is configured to be connected to a second AC power supply network GPU2. According to one embodiment, the power supply networks GPU1 and GPU2 deliver RMS AC voltages of 115 V at a frequency of 400 Hz. In one example, these networks are provided by mobile generator sets located in a parking area of the aircraft AC. Ingeniously, the power supply module APSM is configured to deliver, on an output O1, a DC voltage, also referred to here as DC network HVDCN1, of between 270 V and 1000 V, preferentially of equal to 540 V or 800 V, from the electrical energy supplied by the networks GPU1 and GPU2.

According to a first preferred variant embodiment illustrated in FIG. 2, the power supply module APSM comprises a first power converter module C1, connected to the input I1 and configured to perform rectification and voltage boosting inside the module APSM, as well as a second power converter module C2, connected to the input I2 and configured to perform rectification and voltage boosting inside the module APSM. The outputs of the power converter modules C1 and C2 are placed in parallel, while ensuring that they are regulated at the same voltage level, and joined to deliver the electrical energy which results therefrom in the form of the network HVDCN1, of HVDC (high voltage direct current) type, on the output O1, in order to be able to supply power to the aircraft AC or another aircraft connected to the output O1. Placing in parallel the sources converted into a DC supply is done while ensuring that the amplitudes of the voltages of DC sources are equal. The internal circuits of the power converters C1 and C2 are not detailed here in so far as this is not useful for understanding the invention. A person skilled in the art will know how to determine a voltage-rectifying circuit and a voltage-boosting circuit which are calibrated to meet the specific needs, for example in terms of voltage or power, which are specific to a given aircraft or to a given range of aircraft.

FIG. 3 illustrates another variant embodiment of the module APSM, according to which the AC networks GPU1 and GPU2 are first of all synchronized at the input of the power supply module APSM, by means of a synchronization and junction circuit. The synchronization and junction circuit comprises a synchronization circuit or module ACSM, under the control of an internal controller CTRL as well as a junction circuit at the level of an output SACN. The internal controller CTRL is connected to the inputs I1 and I2 which then drives a synchronization signal SYN to control the synchronization circuit or module ACSM. The internal controller CTRL ensures that the AC sources are correctly regulated at the same voltage level 115 V AC, at the same frequency 400 Hz, and with the same phase order (for example PhA, PhB, PhC). At the level of the output SACN, the output of the synchronization circuit or module ACSM that takes as input the input I2 connected to the network GPU2 is then synchronized with the network GPU1 applied to the input I1. Thanks to this synchronization, the input I2 thus adjusted can be joined with the input I1. The synchronizing and placing in parallel of the AC sources is done while ensuring that all the sources operate with the same phase order (for example a phase A, then a phase B then a phase C), at the same frequency, for example 400 Hz, and with the same amplitude, for example 115 V AC. These last two conditions will be easy to implement due to the fact that all airport electrical sources meet the same standard 115 V AC at 400 Hz. The synchronization output is connected to an input of the power converter, referred to as a rectifier, which makes it possible to convert and regulate the AC voltage into a DC voltage. The converter is configured to deliver, via the output O1, said DC supply voltage from said two synchronized and joined power supply lines.

For example, to perform the synchronization, the internal controller CTRL is configured to measure the voltages, frequencies, and phases of the networks GPU1 and GPU2. Then, based on the frequency difference between the networks GPU1 and GPU2, the phase difference between the networks GPU1 and GPU2, and the voltage difference between the networks GPU1 and GPU2, the internal controller CTRL instructs the synchronization module ACSM to adjust the electrical signal supplied by the input I2 accordingly. A phase-locked loop (PLL) can be used for this purpose.

It is also possible that the networks GPU1 and GPU2 are supplied by generator sets, and that the module APSM can act on one of said generator sets to align the voltage, frequency, and phase of a first network among said networks GPU1 and GPU2 with those of the second network among said networks GPU1 and GPU2. For frequency and phase, the module APSM increases or decreases the engine speed of the generator set associated with the first network according to the adjustment required in line with the difference in frequency and phase measurements taken between the networks GPU1 and GPU2. And to align the voltage of the first network with that of the second network, the synchronization module ACSM adjusts the alternator excitation of the first network according to the necessary adjustment corresponding to the difference in voltage measurements performed between said GPU1 and GPU2 networks.

According to one embodiment, the internal controller CTRL is also used to perform internal configurations of the module ACSM, for example to configure the output voltage level applied to the output O1. According to this second variant embodiment, the synchronized output SACN is connected to the input of the power converter C1 which then performs rectification and voltage boosting to supply the DC voltage HVDCN1 to the output O1. The internal circuits of the synchronization module are not described in greater detail here in so far as they play no part in understanding the invention. Here again, a person skilled in the art will know how to choose a module for synchronizing two analogue networks having variable voltages of the same amplitude, with the aim of then supplying power to a rectifying and voltage-boosting circuit to meet the specific needs, for example in terms of voltage or power, for a given aircraft or a given family of aircraft.

According to one embodiment, the DC voltage supplied on the output O1 by the power supply module APSM is configurable by a user via a control interface directly accessible on the module APSM or accessible remotely. According to one embodiment, the control interface is a keyboard or a multi-position switch implemented directly on the module APSM. According to one variant, the power supply module may be configured via a wireless communication interface, using radio waves, for example from a control centre of an airport facility.

Advantageously, the power supply module APSM is one piece and is configured to be carried on or in a land-based motor vehicle, or on a trailer which is able to be towed or pushed by a land-based motor vehicle, this making it easily movable and making it possible for it to be moved as close as possible to one or more generator sets, close to an aircraft.

According to one embodiment, the internal controller CTRL is configured to automatically detect the presence or the absence of each of the electrical networks GPU1 and GPU2 at the input of the power supply module APSM in order to be able to operate, albeit with a lower output power, if only one network amongst the networks GPU1 and GPU2 is connected to the module APSM.

FIG. 4 schematically illustrates an exemplary internal architecture of the control and synchronization control device CTRL inside the power supply module APSM.

According to the exemplary hardware architecture shown in FIG. 4, the control device CTRL inside the power supply module APSM then comprises, connected by a communication bus CTRLB: a processor or central processing unit (CPU) CTRL1; a random-access memory (RAM) CTRL2; a read-only memory (ROM) CTRL3; a storage unit such as a hard disk (or a reader of a storage medium, such as a reader of secure-digital (SD) cards) CTRL4; a power and communication interface module CTRL5 allowing the control device CTRL inside the power supply module APSM to communicate with remote devices, such as remote sensors, actuators or devices, including in particular one or more aircraft devices.

The processor CTRL1 of the pitch control avionic device is capable of executing instructions loaded into the RAM CTRL2 from the ROM CTRL3, from an external memory (not shown), from a storage medium (such as an SD card), or from a communication network. When the control device CTRL inside the power supply module APSM is powered on, the processor CTRL1 is capable of reading instructions from the RAM CTRL2 and executing them. These instructions form a computer program causing the implementation, by the processor CTRL1 of the control device CTRL inside the power supply module APSM, of all or part of a method for synchronizing the power networks applied to the inputs I1 and I2.

All or part of such a synchronization method may then be implemented in software form by executing a set of instructions using a programmable machine, for example a DSP (digital signal processor) or a microcontroller, or be implemented in hardware form by a machine or a dedicated component, for example an FPGA (field-programmable gate array) or an ASIC (application-specific integrated circuit). In general, the control device CTRL inside the power supply module APSM comprises electronic circuitry configured to implement a method for controlling synchronization of AC power networks. Of course, the control device CTRL inside the power supply module APSM further comprises or is coupled to all of the elements which are usually present in an electronic system comprising a control unit and its peripherals, such as a power supply circuit, a power supply monitoring circuit, one or more clock circuits, a zeroing circuit, input/output ports, interrupt inputs, and bus drivers, this list not being exhaustive.

The invention is not limited solely to the examples and embodiments described but more generally to any power supply module for an aircraft, comprising one or more inputs intended to be supplied with power by AC power sources and comprising circuitry for delivering a DC electrical energy source of HVDC type capable of supplying power to a parked aircraft. In particular, the power supply module may comprise more than two inputs configured to be connected to an AC power supply network, for example 2, 3, 4 or 5 inputs, or even more.

1. A power supply module for supplying power to an aircraft, comprising at least:
a first input configured to make an electrical connection to a first AC distribution network and
a power converter,
the power supply module being external to the aircraft,
the power converter being configured to deliver to said aircraft a DC supply voltage, from at least said first AC distribution network, via an output configured for connection to said aircraft,
wherein the power supply module comprises a second input configured to make a connection to a second AC distribution network, as well as a circuit for synchronizing and joining two AC power supply lines which are connected to said inputs, respectively, an output of which is connected to an input of said power converter configured to deliver, via said output, said DC supply voltage from said two synchronized and joined power supply lines.

2. The power supply module for an aircraft according to claim 1, said power supply module being configured to be connected to a plurality of stationary or mobile generator sets.

3. The power supply module for an aircraft according to claim 1, said power supply module being arranged in a mobile one-piece unit.

4. The power supply module for an aircraft according to claim 1, said supply module being arranged on or in a land-based motor vehicle.

5. The power supply module for an aircraft according to claim 1, wherein the one or more inputs are configured for connection to a network having an AC voltage of 115 V and operating at a frequency of 400 Hz, and said first output being configured to deliver a DC voltage of between 500 V and 1000 V, preferentially of equal to 540 V or 800 V.

6. The power supply module according to claim 1, wherein said first output is configured to deliver a DC voltage which is adjustable via a control user interface of said module.
